(19) United States
(12) Patent Application Publication
(10) Pub. No.: US 2026/0270803 A1
(43) Pub. Date: Sep. 10, 2026

(54) DYNAMIC CONTEXT-AWARE NETWORK HANDOVER (DCANH)

(71) Applicant: AT&T Intellectual Property I, L.P., Atlanta, GA (US)

(72) Inventors: Sangho Oh, San Ramon, CA (US); Yali Liu, Dublin, CA (US); Chan-Ching Hsu, Dublin, CA (US); Michael R. Puzon, Danville, CA (US); Vanessa Tan, San Jose, CA (US)

(73) Assignee: AT&T Intellectual Property I, L.P., Atlanta, GA (US)

(21) Appl. No.: 19/072,416

(22) Filed: Mar. 6, 2025

(51) Int. Cl. H04W 36/00; H04W 36/08; H04W 36/32

(52) U.S. Cl. CPC H04W 36/00222; H04W 36/08; H04W 36/32

(57) ABSTRACT

Aspects of the subject disclosure may include, for example: obtaining location data associated with a mobile communications device; obtaining first operating parameters associated with a base station of a cellular communications network, wherein the base station is in wireless communications with the mobile communications device; obtaining second operating parameters associated with an access point of a non-cellular wireless communications network; determining, based at least in part upon the location data, the first operating parameters, and the second operating parameters, whether the mobile communications device is to handover from the base station to the access point, wherein the determining results in a determination; and responsive to the determination being that the mobile communications device is to handover from the base station to the access point, facilitating the handover of the mobile communications device from the base station to the access point. Other embodiments are disclosed.

### FIELD OF THE DISCLOSURE

The subject disclosure relates to dynamic context-aware network handover (sometimes referred to herein as “DCANH”)

### BACKGROUND

In the current landscape of mobile communications, cellular networks frequently experience congestion, particularly in densely populated areas and/or during peak usage times. Certain cellular service providers actively use Wi-Fi hotspots to offload their cellular network loads. However, in such traditional handover mechanisms, which primarily rely on Wi-Fi signal strength thresholds to trigger the switch from cellular to Wi-Fi networks, the decision making is typically overly simplistic. This can lead to scenarios where a handover to Wi-Fi either occurs unnecessarily or does not happen when it would be beneficial, resulting in a less than optimal Quality of Experience (QoE) for the user.

Over the years, various strategies have been employed or proposed to address the challenges of network congestion and to improve handover decisions. For example, with respect to priority control, some service providers have adopted “Wi-Fi first” policies, where devices are programmed to prefer Wi-Fi connections over cellular whenever Wi-Fi is available. In another example, with respect to enhanced signal strength thresholds, some systems have (to improve upon basic signal strength thresholds) introduced more sophisticated metrics for assessing Wi-Fi quality, such as signal-to-noise ratios or the detection of actual internet connectivity on the Wi-Fi network before attempting a handover.

### BRIEF DESCRIPTION OF THE DRAWINGS

Reference will now be made to the accompanying drawings, which are not necessarily drawn to scale, and wherein:

FIG. 1 is a block diagram illustrating an example, non-limiting embodiment of a communication network in accordance with various aspects described herein.

FIG. 2A is a block diagram illustrating an example, non-limiting embodiment of a system (which can function within the communication network of FIG. 1) in accordance with various aspects described herein.

FIG. 2B is a block diagram illustrating an example, non-limiting embodiment of a system (which can function within the communication network of FIG. 1) in accordance with various aspects described herein.

FIG. 2C is a block diagram illustrating an example, non-limiting embodiment of a process (which can function within the communication network of FIG. 1) in accordance with various aspects described herein.

FIG. 2D depicts an illustrative embodiment of a method in accordance with various aspects described herein.

FIG. 2E depicts an illustrative embodiment of a method in accordance with various aspects described herein.

FIG. 2F depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for dynamic context-aware network handover (e.g., of one or more mobile communications devices from a cellular network to a respective target non-cellular access point). Other embodiments are described in the subject disclosure.

One or more aspects of the subject disclosure include a mobile communications device, comprising: a processing system including a processor; and a memory that stores executable instructions that, when executed by the processing system, facilitate performance of operations, the operations comprising: obtaining location data associated with the mobile communications device; obtaining first operating parameters associated with a base station of a cellular communications network, wherein the base station is in wireless communications with the mobile communications device; obtaining second operating parameters associated with an access point of a non-cellular wireless communications network; determining, based at least in part upon the location data, the first operating parameters, and the second operating parameters, whether the mobile communications device is to handover (sometimes referred to herein as HO) from the base station to the access point, wherein the determining results in a determination; and responsive to the determination being that the mobile communications device is to handover from the base station to the access point, facilitating the handover of the mobile communications device from the base station to the access point.

One or more aspects of the subject disclosure include a non-transitory machine-readable medium, comprising executable instructions that, when executed by a processing system of a mobile communications device including a processor, facilitate performance of operations, the operations comprising: obtaining position data identifying a position of the mobile communications device; obtaining first operating characteristics associated with a base station of a cellular communications network, wherein the base station is in wireless communications with the mobile communications device, and wherein the wireless communications comprise control data over a control channel and data traffic over a traffic channel; scanning a Wi-Fi access point, wherein the scanning provides second operating characteristics associated with the Wi-Fi access point; determining, based at least in part upon the position data, the first operating characteristics, and the second operating characteristics, whether the mobile communications device is to handover from the base station to the Wi-Fi access point, wherein the handover comprises subsequent communications of data traffic between the mobile communications device and the Wi-Fi access point, and wherein the determining results in a determination; and responsive to the determination being that the mobile communications device is to handover from the base station to the Wi-Fi access point, initiating the handover of the mobile communications device from the base station to the Wi-Fi access point.

One or more aspects of the subject disclosure include a method, comprising:
obtaining, by a processing system of a base station including a processor, location data associated with a plurality of end-user mobile devices; obtaining, by the processing system, first operating parameters associated with wireless cellular communications between the base station and each of the end-user mobile devices; obtaining, by the processing system, second operating parameters associated with a plurality of access points of a non-cellular wireless communications network; selecting by the processing system, based at least in part upon the location data, the first operating parameters, and the second operating parameters, a first one of the plurality of access points to which a first one of the end-user mobile devices is to handover; selecting by the processing system, based at least in part upon the location data, the first operating parameters, and the second operating parameters, a second one of the plurality of access points to which a second one of the end-user mobile devices is to handover; transmitting, by the processing system, a first handover recommendation to the first one of the end-user mobile devices, wherein the first handover recommendation identifies the first one of the plurality of access points; and transmitting, by the processing system, a second handover recommendation to the second one of the end-user mobile devices, wherein the second handover recommendation identifies the second one of the plurality of access points.

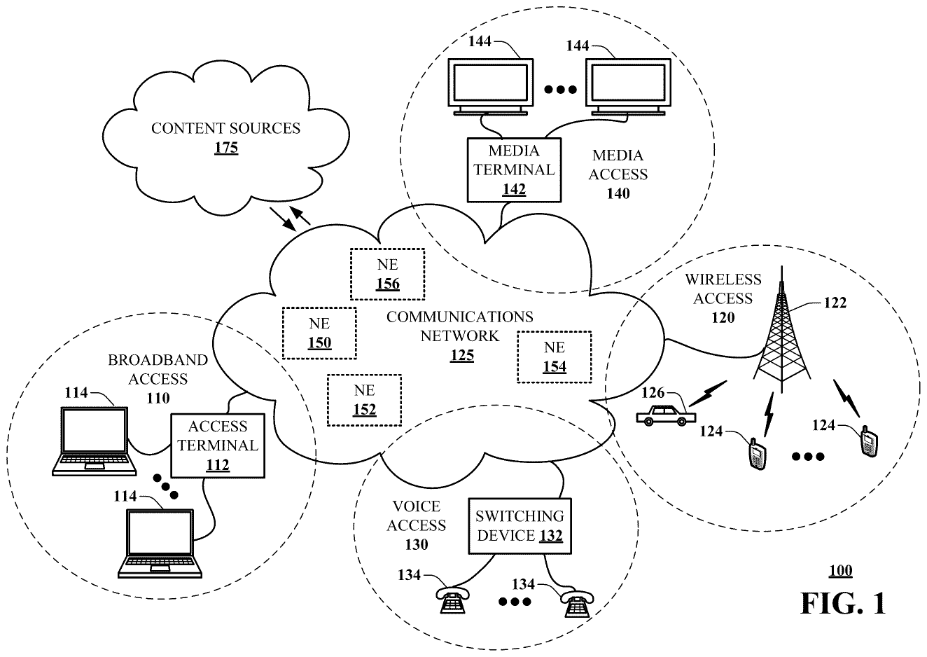

Referring now to FIG. 1, a block diagram is shown illustrating an example, non-limiting embodiment of a system 100 in accordance with various aspects described herein. For example, system 100 can facilitate in whole or in part determining, recommending, instructing, facilitating and/or scheduling handover(s) of one or more mobile communications devices from a cellular network (e.g., 4G cellular network, 5G cellular network, subsequent generation cellular network) to a respective target non-cellular access point (e.g., a Wi-Fi access point). In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

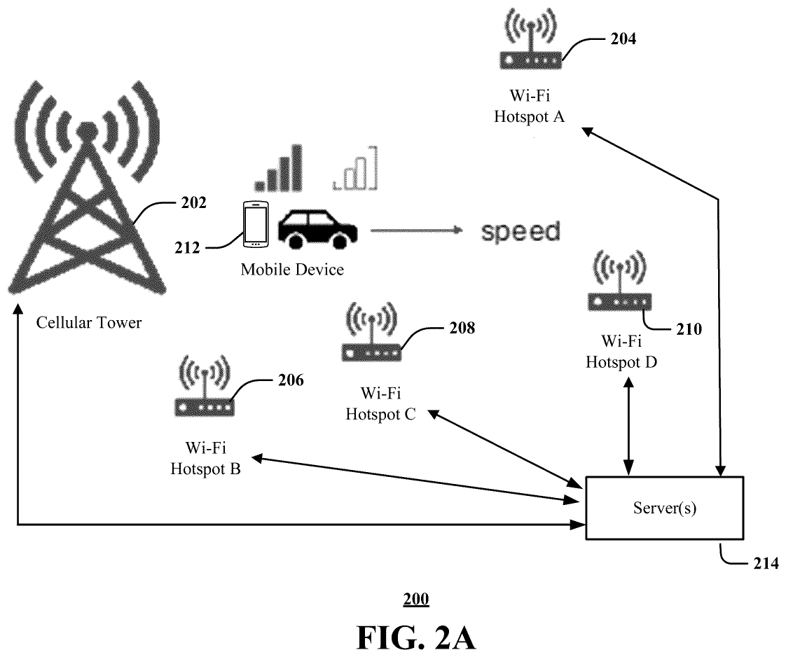

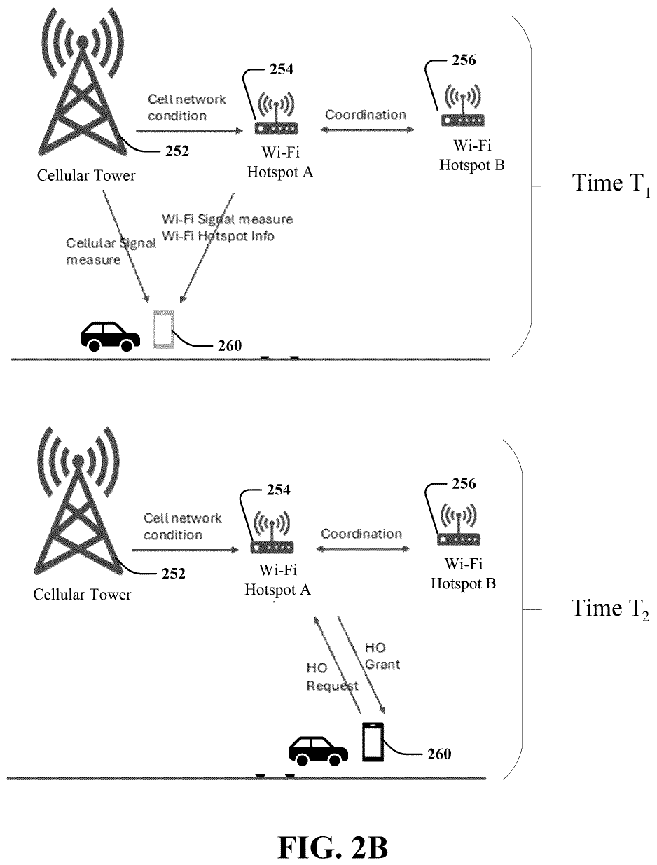

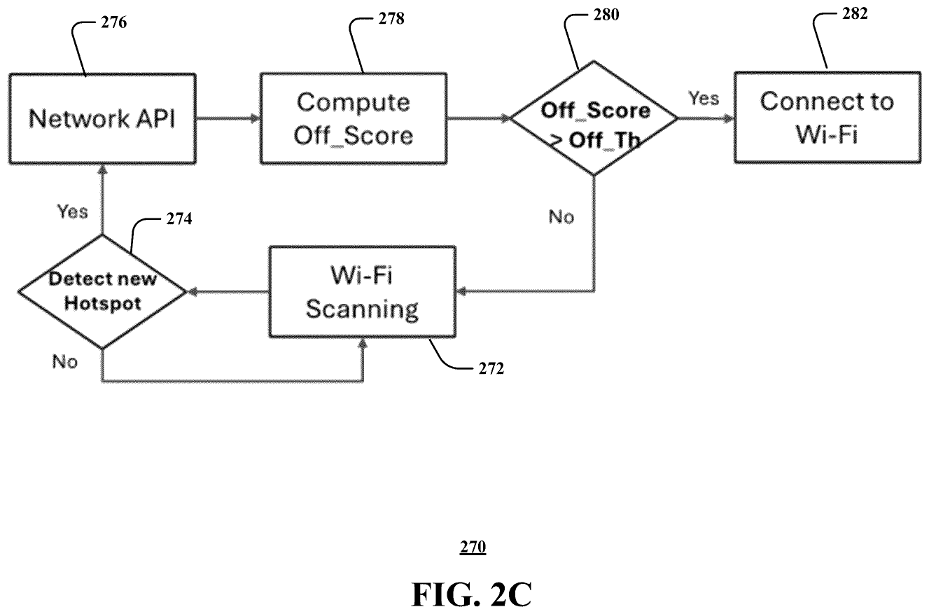

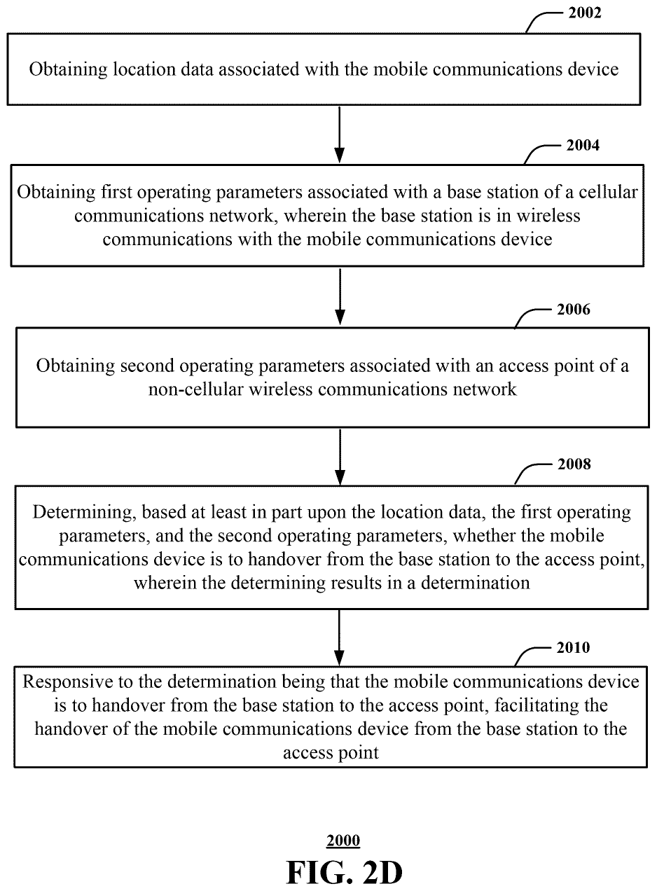

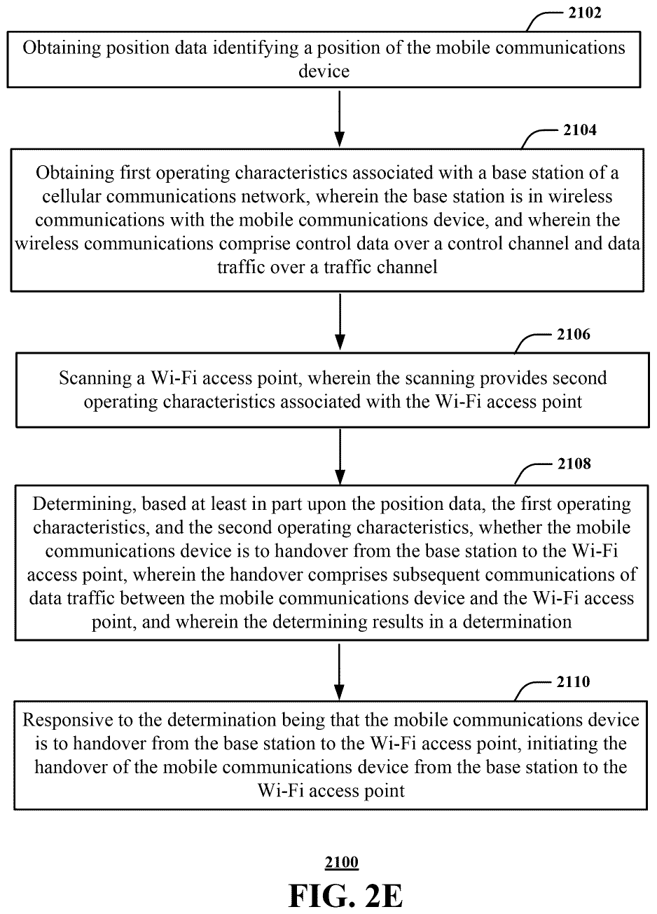

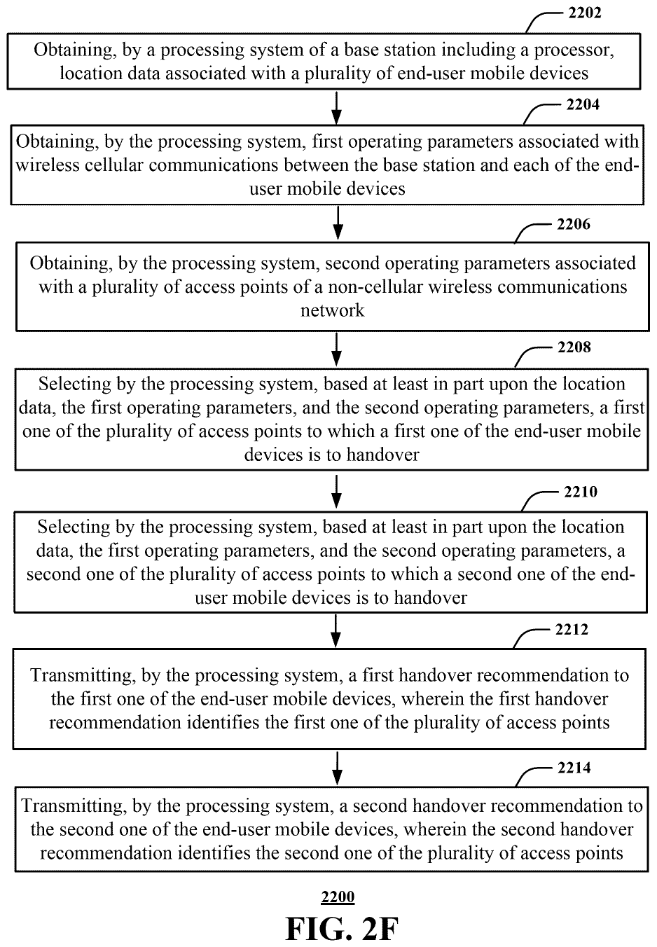

Referring now to FIG. 2A, this is a block diagram illustrating an example, non-limiting embodiment of a system 200 (which can function within the communication network of FIG. 1) in accordance with various aspects described herein. As seen in this figure (which relates to a Wi-Fi handover (offloading) scenario), a cellular base station 202 is configured for bi-directional communications with a mobile communications device 212 (in various examples, the mobile communications device 212 can comprise a cellphone, a smartphone, a tablet computer, a laptop computer, a portion of a connected vehicle, or any combination thereof). Further, server(s) 214 are configured for bi-directional communications with each of cellular base station 202, Wi-Fi hotspot A (element 204), Wi-Fi hotspot B (element 206), Wi-Fi hotspot C (element 208), and Wi-Fi hotspot D (element 210). In operation, server(s) 214 can facilitate determining, recommending, instructing, and/or scheduling handover(s) from cellular base station 202 to one or more of the Wi-Fi hotspots as described herein (e.g., as the mobile communications device 212 moves from one location to another). Of course, while one base station is shown, any desired number of base stations can be supported. Further, while four Wi-Fi hotspots are shown, any desired number of Wi-Fi hotspots can be supported. Further still, while one mobile communications device is shown, any desired number of mobile communications devices can be supported.

Referring now to FIG. 2B, this is a block diagram illustrating an example, non-limiting embodiment of a system (which can function within the communication network of FIG. 1) in accordance with various aspects described herein. As seen in this figure (which relates to a cellular to Wi-Fi handover decision scenario), this scenario begins at a start time T₁ (see the top portion of the figure) and then continues to a later time T₂ (see the bottom portion of the figure). More particularly, in operation starting at time T₁, a cellular base station 252 is engaged in bi-directional communications with a mobile communications device 260 (in various examples, the mobile communications device 260 can comprise a cellphone, a smartphone, a tablet computer, a laptop computer, a portion of a connected vehicle, or any combination thereof). The mobile communications device 260 can measure a cellular signal from cellular base station 252 and also can obtain Wi-Fi signal measurements and Wi-Fi hotspot information associated with Wi-Fi hotspot A (element 254). In addition, cell network condition information and coordination information can be exchanged among cellular base station 252, Wi-Fi hotspot A (element 254), and Wi-Fi hotspot B (element 256) in order to facilitate determining, recommending, instructing, and/or scheduling handover(s) as described herein.

Still referring to FIG. 2B, the description will now continue at a later time T₂ (see the bottom portion of the figure). More particularly, in operation starting at time T₂, mobile communications device 260 has moved to a new position and has also sent a handover request to Wi-Fi hotspot A and received a handover grant from Wi-Fi hotspot A (these handover request and handover grant can be a result of determining, recommending, instructing, and/or scheduling handover(s) as described herein).

Reference will now be made to certain details of an advanced Wi-Fi offloading system (according to various embodiments) that optimizes the use of Wi-Fi networks for cellular traffic offload, enhancing both network efficiency and user experience. Such an advanced Wi-Fi offloading system can intelligently manage the transition of UE between cellular networks and Wi-Fi hotspots based on a comprehensive evaluation of multiple factors, such as UE mobility conditions, Wi-Fi hotspot profile and signal quality, cellular network conditions, and Wi-Fi network conditions, to ensure that offloading occurs under conditions where QoS can be guaranteed.

Still referring to the above-mentioned advanced Wi-Fi offloading system, various embodiments can provide service and application awareness for quality improvement. For instance, an algorithm can integrate service and application awareness into the Wi-Fi offloading decision to substantially enhance the QoS. This can involve characterizing and understanding the types of services and applications the UE is using, such as streaming video, VoIP calls, or data-intensive applications like cloud computing services. In addition, a dynamic QoS assessment can be provided wherein, for example, the algorithm dynamically assesses the QoS of both the cellular and Wi-Fi networks in real-time. Further, the algorithm can consider the expected duration of stay within a Wi-Fi hotspot's coverage, based on the UE's speed and acceleration, and evaluate the quality of the Wi-Fi signal, including factors such as frequency bands and received signal strength indicator (RSSI). Further still, the algorithm can incorporate awareness of the services and applications being used by the UE, tailoring the offloading decision to the specific needs of these applications in terms of bandwidth, latency, and other QoS parameters.

Still referring to the above-mentioned advanced Wi-Fi offloading system, various embodiments can provide intelligent scheduling for multiple UEs. For instance, an intelligent scheduler can manage the access of multiple UEs trying to connect to or disconnect from a Wi-Fi hotspot. This scheduler can prioritize UEs based on a variety of criteria, including their QoS needs and the urgency of their data transmission, ensuring fair and efficient use of the Wi-Fi resource. Further, an algorithm can implement priority-based scheduling. For instance, the algorithm can implement a priority system for UEs based on the QoS requirements, the urgency of data transmission, battery level, and/or historical data usage patterns (e.g., UEs with higher priority scores can be given preferential access to the hotspot). Further still, an algorithm can implement a fair access mechanism. For instance, the algorithm can incorporate a fair scheduling process that ensures all UEs have equitable access to Wi-Fi resources over time. This can be implemented via time-slot allocations and/or dynamically adjusting priorities to prevent any single UE from monopolizing access.

Still referring to the above-mentioned advanced Wi-Fi offloading system, various embodiments can provide smart Wi-Fi hotspot broadcasting. For instance, Wi-Fi hotspots can be configured (according to various embodiments) to actively broadcast their capability and current QoS metrics, enabling UEs to make informed decisions when selecting the best Wi-Fi network for offloading. Such Wi-Fi hotspots (according to various embodiments) can provide dynamic capability broadcasting. For instance, a system (according to various embodiments) can operate such that Wi-Fi hotspots periodically broadcast information about their current load, available bandwidth, latency, and other QoS parameters. This allows UEs to assess whether the hotspot can meet their current needs before attempting to connect. Further, an algorithm can implement UE-hotspot matching. For instance, an algorithm within the UE can operate to match the UE's current service needs against the capabilities of nearby hotspots, selecting the one that best aligns with its QoS requirements. This decision-making process can also consider historical performance data of the hotspots.

Still referring to the above-mentioned advanced Wi-Fi offloading system, various embodiments can provide neighbor hotspot consideration and traffic routing. Such embodiments can address the complexity of environments where multiple hotspots are present, focusing on optimizing the collective performance of the network and enhancing user experience. For instance, hotspot grouping and extenders can be implemented, wherein a system groups nearby hotspots and uses extenders to create a seamless network fabric. Such system can allow UEs to move fluidly between hotspots without significant drops in QoS, leveraging the collective bandwidth and coverage of the grouped hotspots. Further, an algorithm can implement intelligent traffic routing. For instance, advanced routing algorithms can dynamically direct traffic among hotspots based on current load, UE mobility patterns, and QoS requirements. This can make use of predictive modeling to anticipate congestion points and reroute traffic proactively, ensuring optimal network performance.

Referring now to FIG. 2C, this is a block diagram illustrating an example, non-limiting embodiment of a process (which can function within the communication network of FIG. 1) in accordance with various aspects described herein. As seen in this figure, the process can begin with Wi-Fi scanning (see step 272). In one embodiment, such Wi-Fi scanning can be carried out by a mobile communications device. Next (see step 274), a decision is made as to whether or not a new hotspot has been detected by the scanning. If NO, then the process repeats at step 272. If YES, then the process proceeds to Network API (see step 276). In one embodiment, an API can be utilized to obtain network operating parameters. Next (see step 278), a computation of an offload score is made. Next (see step 280), a decision is made as to whether or not the offload score is greater than (or otherwise meets) an offload score threshold. If NO, then the process repeats at step 272. If YES, then the process proceeds to Connect to Wi-Fi (see step 282).

Reference will now be made to certain details of offloading decision and Wi-Fi connection according to various embodiments. More particularly, upon detection of a candidate Wi-Fi hotspot for offloading (see, e.g., step 274 of FIG. 2C), a UE calculates the metrics to use for the decision-making process of Wi-Fi offloading as follows:
Expected Duration of Stay (Ex_Dur): Predicted based on UE's speed and acceleration. Hotspot type (Macro, Residential)
Expected Wi-Fi Quality (Ex_WiFi): Based on the Wi-Fi hotspot's RSSI, type, and frequency band. This can be normalized 0 to 1
Current Cellular Service Quality (Ex_Mobile): Assessed through current bandwidth, signal quality, congestion, and latency. Can be normalized 0 to 1

Still referring to certain details of offloading decision and Wi-Fi connection according to various embodiments, an offloading score can be calculated (see e.g., step 278 of FIG. 2C). Next, the score is compared to a threshold (see, e.g., step 280 of FIG. 2C). Thereafter, if handover is decided to occur, a Wi-Fi connection is made (see, e.g., step 282 of FIG. 2C). More particularly, an example calculation can comprise:
Offloading score: weights (W1, W2, W3)
Off_Score=W1*Ex_Dur*W2*Ex_WiFi-W3*Ex_Mobile
Offloading threshold: Off_Th

Referring now to FIG. 2D, various steps of a method 2000 according to an embodiment are shown. As seen in this FIG. 2D, step 2002 comprises obtaining location data associated with the mobile communications device. Next, step 2004 comprises obtaining first operating parameters associated with a base station of a cellular communications network, wherein the base station is in wireless communications with the mobile communications device. Next, step 2006 comprises obtaining second operating parameters associated with an access point of a non-cellular wireless communications network. Next, step 2008 comprises determining, based at least in part upon the location data, the first operating parameters, and the second operating parameters, whether the mobile communications device is to handover from the base station to the access point, wherein the determining results in a determination. Next, step 2010 comprises responsive to the determination being that the mobile communications device is to handover from the base station to the access point, facilitating the handover of the mobile communications device from the base station to the access point.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2E, various steps of a method 2100 according to an embodiment are shown. As seen in this FIG. 2E, step 2102 comprises obtaining position data identifying a position of the mobile communications device. Next, step 2104 comprises obtaining first operating characteristics associated with a base station of a cellular communications network, wherein the base station is in wireless communications with the mobile communications device, and wherein the wireless communications comprise control data over a control channel and data traffic over a traffic channel. Next, step 2106 comprises scanning a Wi-Fi access point, wherein the scanning provides second operating characteristics associated with the Wi-Fi access point. Next, step 2108 comprises determining, based at least in part upon the position data, the first operating characteristics, and the second operating characteristics, whether the mobile communications device is to handover from the base station to the Wi-Fi access point, wherein the handover comprises subsequent communications of data traffic between the mobile communications device and the Wi-Fi access point, and wherein the determining results in a determination. Next, step 2110 comprises responsive to the determination being that the mobile communications device is to handover from the base station to the Wi-Fi access point, initiating the handover of the mobile communications device from the base station to the Wi-Fi access point.

While for purposes of simplicity of explanation, the respective processes are shown and described as a series of blocks in FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2F, various steps of a method 2200 according to an embodiment are shown. As seen in this FIG. 2F, step 2202 comprises obtaining, by a processing system of a base station including a processor, location data associated with a plurality of end-user mobile devices. Next, step 2204 comprises obtaining, by the processing system, first operating parameters associated with wireless cellular communications between the base station and each of the end-user mobile devices. Next, step 2206 comprises obtaining, by the processing system, second operating parameters associated with a plurality of access points of a non-cellular wireless communications network. Next, step 2208 comprises selecting by the processing system, based at least in part upon the location data, the first operating parameters, and the second operating parameters, a first one of the plurality of access points to which a first one of the end-user mobile devices is to handover. Next, step 2210 comprises selecting by the processing system, based at least in part upon the location data, the first operating parameters, and the second operating parameters, a second one of the plurality of access points to which a second one of the end-user mobile devices is to handover. Next, step 2212 comprises transmitting, by the processing system, a first handover recommendation to the first one of the end-user mobile devices, wherein the first handover recommendation identifies the first one of the plurality of access points. Next, step 2214 comprises transmitting, by the processing system, a second handover recommendation to the second one of the end-user mobile devices, wherein the second handover recommendation identifies the second one of the plurality of access points.

While for purposes of simplicity of explanation, the respective processes are shown and described as a series of blocks in FIG. 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As described herein, various embodiments can (e.g., when making handover decisions) comprehensively take into account dynamic factors such as: the user's speed of movement; the user's direction of movement, the duration within a Wi-Fi coverage area; the current load on the cellular network; the actual quality of the Wi-Fi connection; the specific context of the user; or any combination thereof. Such decision making (according to various embodiments) can reduce occurrences of undesirable scenarios wherein, for example: a handover to Wi-Fi occurs unnecessarily (e.g., when a user is passing quickly through a Wi-Fi area); or a handover does not happen when it would be beneficial (e.g., during cellular network congestion). Further, such decision making (according to various embodiments) can reduce occurrences of scenarios that result in a less than optimal Quality of Experience (QoE) for the user.

As described herein, a DCANH system (according to various embodiments) can provide an intelligent mechanism to automatically switch a cellular phone's connection between cellular and Wi-Fi networks (e.g., based on what's happening around the user). Various embodiments can make handover decisions based upon how strong a Wi-Fi signal is, a UE's moving speed and/or direction, a cellular network congestion status, and/or one or more Wi-Fi hotspot conditions. Various embodiments can make handover decisions in order to ensure that a given UE is always on the best available network. Various embodiments can use intelligent decision making to forecast (or estimate) how good a given Wi-Fi or cellular connection will be before a UE switches over (this can result in fewer dropped calls and/or less buffering of videos).

As described herein, various embodiments can provide a system that facilitates data traffic management and network handover protocols that offer both technical and commercial benefits over various traditional methods. These benefits not only enhance the user experience but can also present significant advantages for network operators. More particularly, these benefits include: (a) Improved Network Efficiency and Reliability-By intelligently managing handovers between cellular and Wi-Fi networks based on real-time context and predictive analytics, DCANH can optimize network resource utilization. This leads to reduced congestion on cellular networks and a more balanced load distribution, ensuring a reliable service even during peak times. (b) Enhanced Quality of Experience (QoE)-DCANH's context-aware decision-making process (according to various embodiments) ensures that handovers occur only when they will improve or maintain the user's connectivity experience. This minimizes disruptions and maximizes connection stability and speed, directly enhancing the QoE. (c) Energy Savings for Users-By avoiding unnecessary network handovers, which can be energy-intensive, and optimizing the use of more energy-efficient Wi-Fi networks, DCANH can contribute to longer battery life for end-user devices. (d) Adaptability and Scalability The use of machine learning algorithms allows DCANH (according to various embodiments) to adapt to changing network conditions, user behaviors, and technological advancements. This scalability ensures that the system remains effective as new challenges and opportunities arise within the telecommunications landscape.

As described herein, various embodiments can provide a smart Wi-Fi offloading algorithm that spans several dimensions, benefiting network operators and users as follows: (a) Enhanced User Experience—By reducing glitches, data offloading between cellular and Wi-Fi networks can significantly improve the user experience (e.g., wherein users benefit from higher data speeds and more stable connections, especially in areas where cellular coverage is limited or congested; this can lead to improved satisfaction with the network provider's service); and/or (b) Optimized Network Utilization—Users will more actively patriciate in Wi-Fi offloading as they can enjoy better network performance (e.g., wherein offloading of traffic from cellular networks to Wi-Fi can alleviate congestion, especially in densely populated areas and/or during peak usage times; this can lead to better utilization of existing infrastructure and potentially delays the need for costly network upgrades or expansions).

As described herein, various embodiments can facilitate an intelligent, flexible, and user-centric approach. Such embodiments can bring significant improvements in both network performance and user satisfaction.

As described herein, various embodiments can facilitate intelligent Wi-Fi handover in dynamic mobile environments.

As described herein, various embodiments can facilitate Wi-Fi offloading and handover only in scenarios where quality of service (QoS) can be guaranteed.

As described herein, various embodiments can utilize network APIs in connection with a smart decision algorithm for Wi-Fi handover (e.g., by assessing the necessity of a Wi-Fi handover at given circumstances).

As described herein, various embodiments can focus on a smart data off-loader that considers UE mobility, Wi-Fi hotspot quality and cellular network conditions (thus providing a mechanism that not only alleviates spectrum shortages but also enhances user experience through improved connectivity options). In various embodiments, handover decisions can also (or in the alternative) take into consideration user preference(s) and/or energy consumption.

As described herein, various embodiments can take into account user equipment (UE) mobility conditions. For instance, speed and acceleration to predict the duration of stay within a Wi-Fi hotspot's coverage.

As described herein, various embodiments can take into account Wi-Fi hotspot profile and signal quality. For instance, Wi-Fi hotspot information can be retrieved directly from the Wi-Fi scanning. Various embodiments can facilitate differentiating between hotspot types (e.g., Residential, Macro), frequency bands (e.g., 2 GHz or 5 GHz), and Received Signal Strength Indicator (RSSI) to estimate the expected Wi-Fi quality.

As described herein, various embodiments can take into account cellular network conditions. For instance, cellular network condition information can be retrieved from a network API for evaluation of the available bandwidth, cellular network (LTE/5G) signal quality, cell congestion, and latency to assess the current cellular service quality.

As described herein, various embodiments can take into account Wi-Fi network conditions. For instance, Wi-Fi network status can be retrieved from a network API provided by the offloading service provider. Information can contain Wi-Fi network status such as Wi-Fi congestion status, number of connected devices and available bandwidth for the offloading.

As described herein, various embodiments can refine the handover process by taking into account a broader range of factors beyond simply Wi-Fi signal strength. By doing so, various embodiments operate to optimize network resource utilization and deliver an improved Quality of Experience (QoE) under diverse conditions.

As described herein, various embodiments can consider the complexities of real-world scenarios. For instance, a device moving quickly through a Wi-Fi hotspot area might not truly benefit from a Wi-Fi handover due to the brief connectivity period, coupled with the high risk of disrupting ongoing calls or data sessions (under this scenario, various embodiments would operate to prohibit or recommend against the handover). Further, in situations where the cellular network is functioning well within its capacity, there's little to no necessity for devices to switch to Wi-Fi (under this scenario, various embodiments would operate to prohibit or recommend against the handover). Conversely, during times of significant cellular network congestion, a more proactive approach to shifting devices to Wi-Fi could alleviate network strain and enhance overall service quality (under this scenario, various embodiments would operate to facilitate or recommend that the handover does occur).

As described herein, various embodiments can utilize a cloud service (e.g., a centralized cloud service) that collects information (e.g., from one or more UEs, from one or more cellular network elements, and/or from one or more Wi-Fi hotspots) and delivers information (e.g., to one or more UEs, to one or more cellular network elements, and/or to one or more Wi-Fi hotspots). The collection and/or delivery of information can be via one or more APIs. In one example, the collection and/or delivery of information can be based upon a request message or the like.

As described herein, various embodiments can implement coordination (of handover) by operation of one or more network elements, by operation of one or more Wi-Fi hotspots, and/or by use of one or more APIs.

As described herein, various embodiments can implement handover decisions by reference to one or more KPIs (e.g., cellular network KPIs, Wi-Fi KPIs, and/or UE KPIs).

As described herein, various embodiments can be implemented via artificial intelligence (AI), generative AI, machine learning (ML), or any combination thereof.

As described herein, any desired ISP and/or telecommunications vendor can use various embodiments to improve network performance.

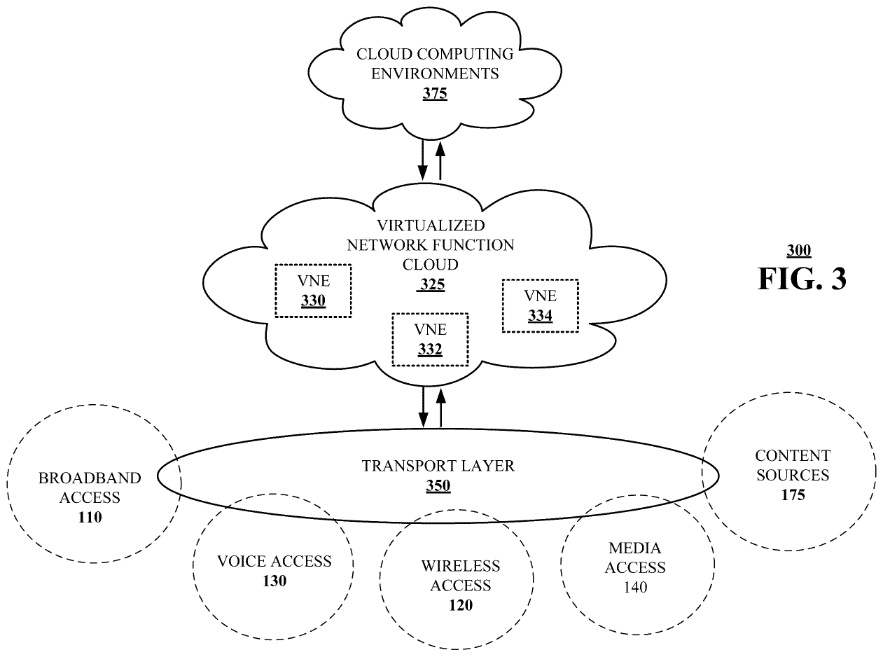

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of the systems presented in FIGS. 1, 2A, 2B, some or all of the functions of the process presented in FIG. 2C, and/or some or all of the functions of the methods presented in FIGS. 2D, 2E, 2F. For example, virtualized communication network 300 can facilitate in whole or in part determining, recommending, instructing, and/or scheduling handover(s) of one or more mobile communications devices from a cellular network (e.g., 4G cellular network, 5G cellular network, subsequent generation cellular network) to a respective target non-cellular access point (e.g., a Wi-Fi access point).

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

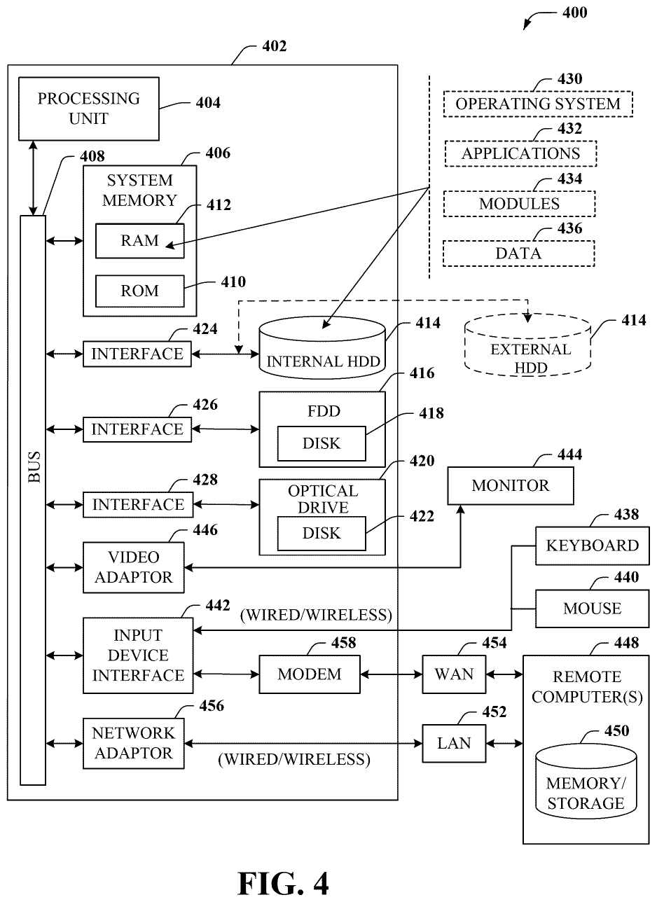

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part determining, recommending, instructing, and/or scheduling handover(s) of one or more mobile communications devices from a cellular network (e.g., 4G cellular network, 5G cellular network, subsequent generation cellular network) to a respective target non-cellular access point (e.g., a Wi-Fi access point).

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

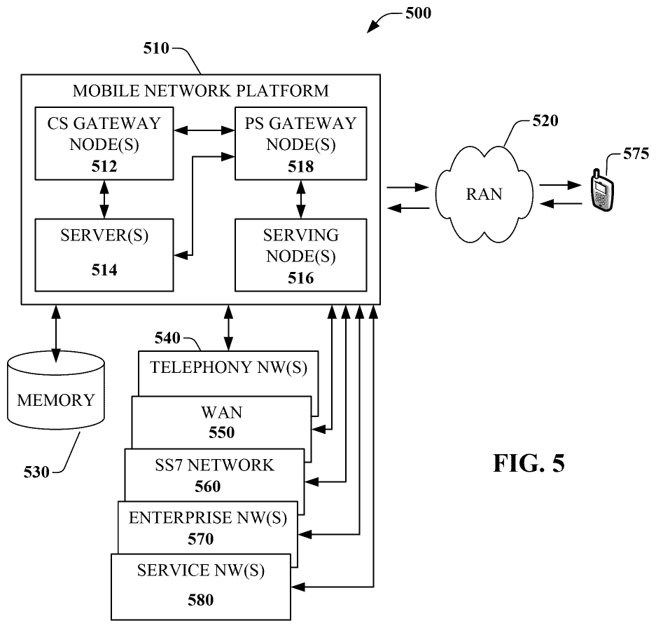

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part determining, recommending, instructing, and/or scheduling handover(s) of one or more mobile communications devices from a cellular network (e.g., 4G cellular network, 5G cellular network, subsequent generation cellular network) to a respective target non-cellular access point (e.g., a Wi-Fi access point). In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

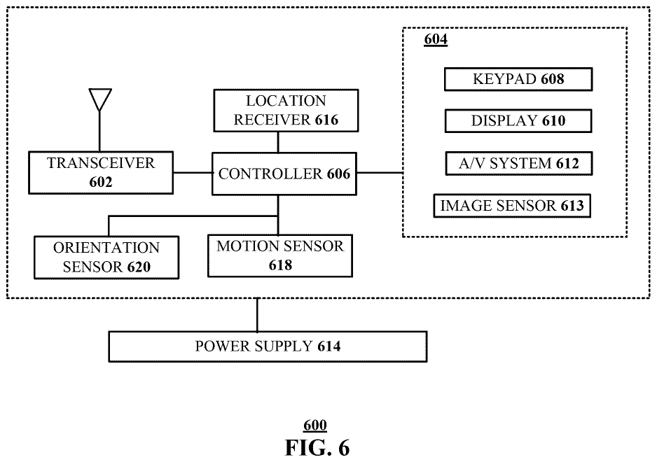

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part determining, recommending, instructing, and/or scheduling handover(s) of one or more mobile communications devices from a cellular network (e.g., 4G cellular network, 5G cellular network, subsequent generation cellular network) to a respective target non-cellular access point (e.g., a Wi-Fi access point).

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically determining, recommending, instructing, facilitating and/or scheduling handover(s) of one or more mobile communications devices from a cellular network (e.g., 4G cellular network, 5G cellular network, subsequent generation cellular network) to a respective target non-cellular access point (e.g., a Wi-Fi access point)) can employ various AI-based schemes for carrying out various embodiments thereof. Moreover, a classifier can be employed to determine a ranking or priority of each mobile communications device, each end-user device and/or each access point. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the mobile communications device(s), end-user device(s) and/or access point(s) is to receive priority.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A mobile communications device, comprising:
a processing system including a processor; and
a memory that stores executable instructions that, when executed by the processing system, facilitate performance of operations, the operations comprising:
obtaining location data associated with the mobile communications device;
obtaining first operating parameters associated with a base station of a cellular communications network, wherein the base station is in wireless communications with the mobile communications device;
obtaining second operating parameters associated with an access point of a non-cellular wireless communications network;
determining, based at least in part upon the location data, the first operating parameters, and the second operating parameters, whether the mobile communications device is to handover from the base station to the access point, wherein the determining results in a determination; and
responsive to the determination being that the mobile communications device is to handover from the base station to the access point, facilitating the handover of the mobile communications device from the base station to the access point.

2. The mobile communications device of claim 1, wherein the mobile communications device comprises one of: a smartphone; a cellular phone; a tablet computer; a laptop computer; a notebook computer; a communications element of a vehicle; or any combination thereof.

3. The mobile communications device of claim 1, wherein the cellular communications network comprises one of: a fourth generation (4G) wireless cellular network; a fifth generation (5G) wireless cellular network; a sixth generation (6G) wireless cellular network; a subsequent generation wireless cellular network; or any combination thereof.

4. The mobile communications device of claim 1, wherein the access point comprises a Wi-Fi access point.

5. The mobile communications device of claim 1, wherein the facilitating the handover of the mobile communications device from the base station to the access point comprises sending of a request for the handover from the mobile communications device to the access point.

6. The mobile communications device of claim 1, wherein the location data comprises one of: GPS data obtained by the mobile communications device from one or more satellites; position data associated with the mobile communications device based upon a base station triangulation calculation; position data associated with the mobile communications device based upon communication with a given base station; or any combination thereof.

7. The mobile communications device of claim 1, wherein the location data comprises one of: a position of the mobile communications device; a direction of movement of the mobile communications device; a speed of movement of the mobile communications device; or any combination thereof.

8. The mobile communications device of claim 7, wherein:
the position of the mobile communications device comprises one of: one or more historic positions of the mobile communications device; a current position of the mobile communications device; one or more future predicted positions of the mobile communications device; or any first combination thereof;
the direction of movement of the mobile communications device comprises one of: one or more historic directions of movement of the mobile communications device; a current direction of movement of the mobile communications device; one or more future predicted directions of movement of the mobile communications device; or any second combination thereof; and
the speed of movement of the mobile communications device comprises one of:
one or more historic speeds of movement of the mobile communications device; a current speed of movement of the mobile communications device; one or more future predicted speeds of movement of the mobile communications device; or any third combination thereof.

9. The mobile communications device of claim 1, wherein the first operating parameters comprise one of: a communications latency available between the mobile communications device and the base station; a communications bandwidth available between the mobile communications device and the base station; an upload speed available between the mobile communications device and the base station; a download speed available between the mobile communications device and the base station; a communications frequency available between the mobile communications device and the base station; a communications frequency range available between the mobile communications device and the base station; a communications load being carried by the base station; or any combination thereof.

10. The mobile communications device of claim 9, wherein:
the communications latency comprises one of: one or more historic communications latencies; a current communications latency; one or more future predicted communications latencies; or any first combination thereof;
the communications bandwidth comprises one of: one or more historic communications bandwidths, a current communications bandwidth; one or more future predicted communications bandwidths; or any second combination thereof;
the upload speed comprises one of: one or more historic upload speeds; a current upload speed; one or more future predicted upload speeds; or any third combination thereof;
the download speed comprises one of: one or more historic download speeds; a current download speed; one or more future predicted download speeds; or any fourth combination thereof;
the communications frequency comprises one of: one or more historic frequencies; a current frequency; one or more future predicted frequencies; or any fifth combination thereof;
the communications frequency range comprises one of: one or more historic frequency ranges; a current frequency range; one or more future predicted frequency ranges; or any sixth combination thereof; and
the communications load comprises one of: one or more historic communications loads; a current communications load; one or more future predicted communications loads; or any seventh combination thereof.

11. The mobile communications device of claim 1, wherein the second operating parameters comprise one of: a predicted communications latency that would be available between the mobile communications device and the access point; a predicted communications bandwidth that would be available between the mobile communications device and the access point; a predicted upload speed that would be available between the mobile communications device and the access point; a predicted download speed that would be available between the mobile communications device and the access point; a predicted communications frequency that would be available between the mobile communications device and the access point; a predicted communications frequency range that would be available between the mobile communications device and the access point; an historic communications load that was carried by the access point; a current communications load that is being carried by the access point; a predicted communications load that will be carried by the access point; or any combination thereof.

12. A non-transitory machine-readable medium, comprising executable instructions that, when executed by a processing system of a mobile communications device including a processor, facilitate performance of operations, the operations comprising:
obtaining position data identifying a position of the mobile communications device;
obtaining first operating characteristics associated with a base station of a cellular communications network, wherein the base station is in wireless communications with the mobile communications device, and wherein the wireless communications comprise control data over a control channel and data traffic over a traffic channel;
scanning a Wi-Fi access point, wherein the scanning provides second operating characteristics associated with the Wi-Fi access point;
determining, based at least in part upon the position data, the first operating characteristics, and the second operating characteristics, whether the mobile communications device is to handover from the base station to the Wi-Fi access point, wherein the handover comprises subsequent communications of data traffic between the mobile communications device and the Wi-Fi access point, and wherein the determining results in a determination; and
responsive to the determination being that the mobile communications device is to handover from the base station to the Wi-Fi access point, initiating the handover of the mobile communications device from the base station to the Wi-Fi access point.

13. The non-transitory machine-readable medium of claim 12, wherein the initiating the handover comprises sending of a message from the mobile communications device to the Wi-Fi access point to request the handover.

14. The non-transitory machine-readable medium of claim 12, wherein the first operating characteristics are sent to the mobile communications device from the base station via an application programming interface (API).

15. The non-transitory machine-readable medium of claim 14, wherein the first operating characteristics are sent to the mobile communications device from the base station via the API in response to receipt by the base station of a request from the mobile communications device via the API.

16. The non-transitory machine-readable medium of claim 12, wherein the second operating characteristics are sent to the mobile communications device from the Wi-Fi access point via an application programming interface (API).

17. The non-transitory machine-readable medium of claim 16, wherein the second operating characteristics are sent to the mobile communications device from the Wi-Fi access point via the API in response to receipt by the Wi-Fi access point of a request from the mobile communications device via the API.

18. A method, comprising:
obtaining, by a processing system of a base station including a processor, location data associated with a plurality of end-user mobile devices;
obtaining, by the processing system, first operating parameters associated with wireless cellular communications between the base station and each of the end-user mobile devices;
obtaining, by the processing system, second operating parameters associated with a plurality of access points of a non-cellular wireless communications network;
selecting by the processing system, based at least in part upon the location data, the first operating parameters, and the second operating parameters, a first one of the plurality of access points to which a first one of the end-user mobile devices is to handover;
selecting by the processing system, based at least in part upon the location data, the first operating parameters, and the second operating parameters, a second one of the plurality of access points to which a second one of the end-user mobile devices is to handover;
transmitting, by the processing system, a first handover recommendation to the first one of the end-user mobile devices, wherein the first handover recommendation identifies the first one of the plurality of access points; and
transmitting, by the processing system, a second handover recommendation to the second one of the end-user mobile devices, wherein the second handover recommendation identifies the second one of the plurality of access points.

19. The method of claim 18, wherein:
the first handover recommendation comprises a first scheduled time; and
the second handover recommendation comprises a second scheduled time.

20. The method of claim 18, wherein each of the transmitting of the first handover recommendation and the transmitting of the second handover recommendation is carried out via an application programming interface (API).
